(19) United States
(12) Patent Application Publication
(10) Pub. No.: US 2015/0194670 A1
(43) Pub. Date: Jul. 9, 2015

(54) MICRON SIZED ANODE ACTIVE MATERIAL CONTAINING TITANIUM DIOXIDE NANOPARTICLES AND METHOD FOR THE PREPARATION THEREOF

(71) Applicant: Research & Business Foundation SUNGKYUNKWAN UNIVERSITY, Suwon-si (KR)

(72) Inventor: Jaehoon KIM, Seongnam-si (KR)

(73) Assignee: Research & Business Foundation SUNGKYUNKWAN UNIVERSITY, Suwon-si (KR)

(21) Appl. No.: 14/591,655

(22) Filed: Jan. 7, 2015

(30) Foreign Application Priority Data
Jan. 8, 2014 (KR) 10-2014-0002139

(51) Int. Cl. H01M 4/48; H01M 4/139; H01M 4/04; H01M 4/13; H01M 4/36; H01M 4/62

(52) U.S. Cl. CPC H01M 4/483; H01M 4/366; H01M 4/625; H01M 4/626; H01M 4/0402; H01M 4/0471; H01M 4/13; H01M 4/139; H01M 2004/021

(57) ABSTRACT

A micron-sized anode active material containing titanium dioxide nanoparticles double-coated with titanium(III) ions (Ti³⁺) and carbon, wherein the titanium dioxide nanoparticles are coupled to one another to form a micron-sized structure, thereby forming pores between the nanosized particles.

### CROSS-REFERENCE TO RELATED APPLICATION

This application claims the benefit of priority under 35 U.S.C. §119(a) of Korean Patent Application No. 10-2014-0002139, filed on Jan. 8, 2014, in the Korean Intellectual Property Office, the entire disclosure of which is incorporated herein by reference for all purposes.

### FIELD

Various embodiments of the present invention relate to a micron-sized anode active material containing titanium dioxide nanoparticles and a method for preparation thereof, and more particularly, to a micron-sized anode active material containing titanium dioxide nanoparticles uniformly double-coated with titanium(III) ions (Ti³⁺) and ultrathin carbon layer that are conductive materials, the titanium dioxide nanoparticles loosely agglomerated with neighboring nanoparticles so as to form pores, thereby increasing transport kinetics of electrons and lithium ions, making electrolyte penetration through pores easier, improving electrochemical performance of the nano size particles and energy density due to the micron sized particles, and a method for preparation thereof.

### BACKGROUND

Lithium secondary batteries of high energy density are widely used as a power source in information related apparatuses and communication apparatuses such as portable computers, mobile phones, and cameras etc.

Furthermore, in order to reduce the dependency on oil and fundamentally alleviate greenhouse gases, developments are being made competitively on PHEV (Plug-in Hybrid Electric Vehicles) and electric vehicles that use lithium secondary batteries as an energy source.

Not only that, as demand for medium and large size secondary batteries is expected to grow significantly in various fields including robotics, backup power, medical devices, gearing tools, UPS (uninterruptible power supply), and ESS (energy storage systems), research and development on secondary batteries are proactively underway.

Especially, electric automobiles, gearing tools, UPS (uninterruptible power supply), and ESS (energy storage systems) must be charged or discharged at a high-rate, and thus these apparatuses need highly stable lithium secondary batteries that are adequate for a high-rate charge/discharge.

Currently, various types of carbon anode active materials containing artificial graphite, natural graphite, hard carbon, and soft carbon where lithium ions can be inserted/deinserted are being widely used as anode active materials for lithium secondary batteries.

The aforementioned carbon anode active materials are advantageous in that they have operating voltages similar to that of lithium metal, have structure stability, may be inserted/deinserted lithium ions reversibly for a long period of time, and have excellent life expectancy. However, the carbon-based anode active materials are problematic for use in the large-scale battery applications due to the energy density per unit volume of a battery. Furthermore, the carbon-based anode active materials have oxidation/reduction potential that is about 0.1V lower than a potential of Li/Li⁺, and thus may be decomposed by reaction with an organic electrolyte that is used in batteries. The carbon-based anode active materials may react with lithium to form a solid electrolyte interface (hereinafter referred to as SEI film) that would cover the carbon surface, thereby deteriorating charge/discharge characteristics. Especially, in application areas such as electric automobiles that require high-rate performance, formation of an SEI film increases resistance during insertion/deinsertion of lithium ions, thereby deteriorating the high-rate characteristics. Not only that, there is also a safety problem that when being charged/discharged at a high rate; there is a possibility that lithium metal dendrites formed on the surface of the carbon-based active material may react with electrolyte and cathode material, which cause battery explosion.

Therefore, in order to realize mass production of medium and large size lithium secondary batteries, there is a growing need for a new type of anode active material that has high performance, stability, and reliability. Recently, titanium dioxide (TiO₂) having high performance, stability, and reliability are gathering attention as a potential anode active materials for medium and large size secondary batteries.

TiO₂ has an oxidation/reduction potential that is 1.5-1.8V higher than the potential of Li/Li⁺, and thus there is almost no possibility that the electrolyte solution will decompose, and there is a low possibility that an SEI film will be formed. Furthermore, due to the high oxidation/reduction potential, there is almost no possibility that lithium of a metal-type will be educed during high velocity charging/discharging of a carbon-based anode active material, and thus TiO₂ has excellent stability during a high velocity charging/discharging, and can be utilized as a power source for PHEV, electrical automobiles, gearing tools, and uninterruptible power supplies. Furthermore, the theoretical density of TiO₂ is about 4.23 g/cm³, which is much higher than carbon. Therefore, TiO₂ having high performance, stability, and reliability has been spotlighted as a new anode active material for large size secondary batteries of energy storage systems due to its high stability, charge/discharge characteristics at high-rates and reliability.

However, due to an extremely low electroconductivity (10⁻¹²-10⁻⁷ S·cm⁻¹) and an extremely low lithium ion diffusivity (˜10⁻¹⁵-10⁻⁹ cm^{2·}s⁻¹), even if an insertion/deinsertion distance of lithium ions can be reduced using not only a micron-sized particles (10-100 μm; the Brunauer-Emmett-Teller (BET) specific surface area 2-5 m²/g) but also nano-sized particles (10-50 nm: BET specific surface area 50-100 m²/g), there is a problem that an insertion/deinsertion kinetics of lithium ions during charge/discharge will be too slow, reducing a charge/discharge capacity to as small as about 70% of its theoretical capacity, and also further deteriorating the lithium storage capacity during charge/discharge at high rates. Due to these problems, TiO₂ is yet to be widely used as an anode active material of lithium secondary batteries.

Existing methods for increasing a charge/discharge capacity of TiO₂ include: improving the electroconductivity through carbon coating or doping etc.; improving the insertion/deinsertion kinetics of lithium ions by adjusting shapes of particles to nanorod, nanowire, and nanotube etc.; and improving the contacting area between electrolyte solution and electrode material by forming a nano structure. To achieve these goals, a solid-state method and water- or organic solution-based methods have been widely investigated. However, preparing nano-sized particles using a solid-state method such as ball milling consumes a lot of energy and requires an additional grinding process for a long period of time, thereby reducing productivity and increasing particle distribution. In the cases of solution-based methods such as a hydrothermal method, co-precipitation, emulsion-drying, and sol-gel method, a long reaction time is required, a lot of toxic chemicals have to be used, organic waste liquid is generated, costly structure-directing chemicals such as soft templates (e.g., block copolymers, surface active agents that are essential in forming a nano structure) and hard templates (e.g., mesoporous carbon, mesoporous silica) are needed, and also due to the numerous processes for arrangements to remove those structure-directing chemicals, it is very difficult to practically mass produce TO₂ having a nano structure.

Furthermore, carbon coating TiO₂ having a nano structure by a solid-state method or liquid-phase method has a disadvantage that carbon is not coated uniformly on the surface of particles due to the small size of the particles, and thus failing to provide excellent charge/discharge characteristics.

### PRIOR ART DOCUMENTS

### Patent Documents

(Patent document 1) Korean patent publication no. 10-2012-0093487
(Patent document 2) Korean patent publication no. 10-2010-00127433
(Patent document 3) Korean patent publication no. 10-2011-0114392

### SUMMARY

Therefore, a purpose of various embodiments of the present invention is to provide anode active material particles containing titanium dioxide nanoparticles uniformly double-coated with titanous(III) ions (Ti³⁺) and carbon so as to increase electroconductivity and ion conductivity, thereby providing excellent charge/discharge characteristics of lithium ions, making electrolyte penetration through pores easier, and improving energy density due to formation of a nano-to-micron sized hierarchical structure where nano particles are coupled to one another.

According to an embodiment of the present invention, there is provided a micron sized anode active material comprising titanium dioxide nanoparticles double-coated with titanium(III) ions (Ti³⁺) and carbon, wherein the titanium dioxide nanoparticles are coupled to one another to form a micron sized structure, thereby forming pores.

A thickness of the double-coating may be 0.3 nm to 1.5 nm.

A diameter of the titanium dioxide nanoparticle may be 20 nm to 50 nm.

According to another embodiment of the present invention, there is provided a method for preparing a micron-sized anode active material containing titanium dioxide nanoparticles, the method including agitating a titanium precursor solution containing titanium dioxide precursor and a solvent under a supercritical fluid condition to prepare an anode active material; collecting the anode active material; washing and drying the anode active material; and calcining the anode active material.

The supercritical fluid condition may be a temperature of 200° C. to 600° C. and a pressure of 30 bar to 600 bar, and a concentration of the titanium precursor solution may be 0.001 mol/L to 10 mol/L. The agitating may be performed for 1 minute to 6 hours.

The collecting may be performed by a centrifugation or filtering method, and the drying may be performed for 5 to 50 hours at a temperature of 30° C. to 100° C.

The calcining may be performed for 10 minutes to 24 hours at a temperature of 300° C. to 1000° C., the calcining may be performed under a condition where an inert gas or an inert gas comprising H₂ flows, and the gas may flow at a velocity of 50 ml/min to 200 ml/min.

The solvent may be alcohol, and the alcohol may be selected from a group consisting of methanol, ethanol, propanol, isopropylalcohol, butanol, isobutanol, 2-butanol, tert-butanol, n-pentanol, isopentyl alcohol, 2-methyl-1-butanol, neopentyl alcohol, diethyl methanol, methyl propyl methanol, methyl isopropyl methanol, dimethyl ethyl methanol, 1-hexanol, 2-hexanol, 3-hexanol, 2-methyl-1-pentanol, 3-methyl-1-pentanol, 4-methyl-1-pentanol, 2-methyl-2-pentanol, 3-methyl-2-pentanol, 4-methyl-2-pentanol, 2-methyl-3-pentanol, 3-methyl-3-pentanol, 2,2-dimethyl-1-butanol, 2,3-dimethyl-1-butanol, 2,3-dimethyl-2-butanol, 3,3-dimethyl-1-butanol, 2-ethyl-1-butanol, 1-heptanol, 2-heptanol, 3-heptanol, and 4-heptanol.

The titanium precursor may be selected from a group consisting of titanium(IV) tetramethoxide, titanium(IV) tetraethoxide, titanium(IV) tetrapropoxide, titanium(IV) tetraisopropoxide, titanium(IV) tetrabutoxide, titanium(IV) tetraisobutoxide, titanium(IV) tetrapentoxide, titanium(IV) tetraisopentoxide, and a salt thereof.

According to various embodiments of the present invention, titanium dioxide nanoparticles coupled to one another and form a micron sized hierarchical structure having a high energy density.

Furthermore, as the titanium dioxide nanoparticles are coupled to one another, pores are formed, and electrolyte penetration through pores becomes easier, thereby improving the electrochemical activity of titanium dioxide nanoparticles.

Furthermore, as the titanium dioxide nanoparticles of which surfaces have been reformed are calcined, and then evenly coated with titanium(III) ions (Ti³⁺) and carbon, the electroconductivity and ion conductivity are improved, providing an anode active material having excellent lithium ion charge/discharge characteristics.

Furthermore, according to various embodiments of the present invention, a hierarchical structure may be formed using only a solvent even without having to add a material that accompanies an additional change of structure, thereby saving energy.

### BRIEF DESCRIPTION OF THE DRAWINGS

FIG. 1 is a graph of anode active material nanoparticles prepared according to embodiment 1 and comparative examples 1 to 3 measured by an XRD (X-ray Diffractormeter);

FIG. 2 is a graph of anode active material nanoparticles prepared by embodiment 1 and comparative examples 1 to 3 measured by a Fourier Transform Infrared Spectroscopy (FT-IR);

FIG. 3 is a graph of anode active material nanoparticles prepared according to embodiment 1 and comparative examples 1 to 3 measured by a Raman spectroscopy;

FIG. 4 illustrates photographs of anode active material nanoparticles prepared according to embodiments 1 and comparative examples 1 to 3 taken by a Scanning electron microscope (SEM);

FIG. 5 illustrates photographs of anode active material nanoparticles prepared according to embodiment 1(a), and comparative examples 2(b) and 3(c) taken by a transmission electron microscopy (TEM);

FIG. 6 illustrates photographs of anode active material nanoparticles prepared according to embodiment 1(a), and comparative examples 1(b), 2(c), and 3(d) taken by a High-Resolution Transmission electron microscopy (HR-TEM);

FIG. 7 illustrates graphs of anode active material nanoparticles prepared according to embodiment 1, and comparative examples 1 to 3 measured by an X-ray photoelectron spectroscopy (XPS);

FIG. 8 illustrates graphs of anode active material nanoparticles prepared according to embodiment 1, and comparative examples 1 to 3 measured by an Nitrogen adsorption and desorption method;

FIG. 9 is a graph of an initial charge/discharge cycle of a battery containing anode active material nanoparticles prepared according to embodiment 1 and comparative examples 1 to 3 measured at 0.1 C at 1.0˜2.5 V;

FIG. 10 is a graph of an initial charge/discharge cycle of a battery containing anode active material nanoparticles prepared according to embodiment 1 and comparative examples 1 to 3 measured at 1.0 C;

FIG. 11 is a graph of charge/discharge properties of a battery containing anode active material nanoparticles prepared according to embodiment 1 and comparative examples 1 to 3 measured while changing a charge/discharge velocity under conditions from 0.1 C to 8 C; and

FIG. 12 is a flowchart sequentially illustrating a method for preparing a micron sized anode active material containing titanium dioxide nanoparticles according to an embodiment of the present invention.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

Embodiments of the present invention relate to a micron size anode active material comprising titanium dioxide nanoparticles, wherein titanium dioxide nanoparticles double-coated with titanium(III) ions (Ti³⁺) and carbon are coupled to one another, thereby forming pores.

Titanium dioxide nanoparticles may be double-coated with titanium(III) ions (Ti³⁺) and carbon. Desirably, the titanium dioxide nanoparticles may be first coated with titanium(III) ions (Ti³⁺), and then the titanium(III) ions (Ti³⁺) may be double-coated with carbon on top of the ion layers.

Herein, a thickness of the double-coated layer may be 0.3 to 1.5 nm, and desirably 0.5 to 1.0 nm. Manufacturing a double-coated layer to have a thickness of less than 0.3 nm would be difficult, and thus uneconomical and also reduce electroconductivity. On the other hand, manufacturing a double-coated layer to have a thickness that exceeds 1.5 nm would reduce the activity of titanium dioxide.

A diameter of a titanium dioxide nanoparticle double-coated as aforementioned may be 20 to 50 nm, and desirably 25 to 40 nm. If a diameter of the double-coated titanium dioxide nanoparticle is less than 20 nm, the proportion of the coated layer will increase, thereby reducing anode activity, whereas when the diameter of the double-coated titanium dioxide exceeds 50 nm, the number of particles coupled to one another in micro size will be reduced, thereby reducing energy density.

Herein, titanium dioxide nanoparticles double-coated as aforementioned are primary particles, and the primary particles may be coupled to one another to form micron sized anode active material particles that are secondary particles.

The primary particles are coupled to one another, forming pores through which electrolyte can easily penetrate, thereby improving electrochemical activity.

Herein, an average diameter of the pores may be 5 to 20 nm, and desirably, 7 to 15 nm. That is because if the average diameter of the pores is less than 5 nm, the penetration efficiency of the electrolyte will decrease, whereas if the average diameter of the pores is 20 nm or above, energy density will decrease.

Furthermore, as titanium dioxide nanoparticles that are primary particles are coupled to one another, forming pores, anode active material that are secondary particles will be formed.

Herein, the micron sized anode active material may have a diameter of 1.0 to 3.0 μm, and desirably 1.5 to 2.5μm. If the micron sized anode active material has a diameter of less than 1.0 μm, due to decrease in energy density, electroconductivity will decrease, whereas if the micron sized anode active material exceeds 3.0 μm, charge/discharge velocity will decrease.

Hereinafter, a method for preparing a micron sized anode active material containing titanium dioxide nanoparticles according to an embodiment of the present invention will be explained in detail.

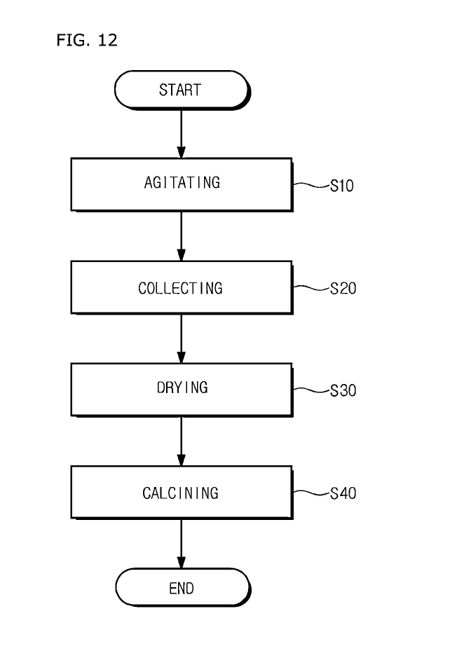

FIG. 12 is a flowchart sequentially illustrating a method for preparing a micron sized anode active material containing titanium dioxide nanoparticles according to an embodiment of the present invention.

Referring to FIG. 12, a method for preparing a micron sized anode active material containing titanium dioxide nanoparticles according to an embodiment of the present invention includes agitating (S10), collecting (S20), drying (S30), and calcining (S40).

The agitating (S10) is a step of preparing a micron sized anode active material by agitating a titanium precursor solution containing titanium precursor nanoparticles and a solvent under supercritical fluid conditions so that titanium dioxide nanoparticles are coupled to one another and pores are formed.

Herein, titanium precursor nanoparticles may be selected from, but without limitation, titanium(IV)tetramethoxide, titanium(IV)tetraethoxide, titanium(IV)tetrapropoxide, titanium(IV)tetraisoproproxide, titanium(IV)tetrabutoxide, titanium(IV)tetraisobutoxide, titanium(IV)tetrapentoxide, titanium(IV)tetraisopentoxide, and a salt thereof, and more desirably, titanium(IV)tetraisopropoxide.

The solvent may be alcohol, and desirably may be selected from methanol (critical temperature=239° C.; critical pressure=81 bar), ethanol (critical temperature=241° C.; critical pressure=63 bar), propanol (critical temperature=264° C.; critical pressure=52 bar), isopropylalcohol (critical temperature=307° C.; critical pressure=41 bar), butanol (critical temperature=289° C.; critical pressure=45 bar), isobutanol (critical temperature=275° C.; critical pressure=45 bar), 2-butanol (critical temperature=263° C.; critical pressure=42 bar), tert-butanol (critical temperature=233° C.; critical pressure=40 bar), n-pentanol (critical temperature=307° C.; critical pressure=39 bar), isopentylalcohol (critical temperature=306° C.; critical pressure=39 bar), 2-methyl-1-butanol (critical temperature=302° C.; critical pressure=39 bar), neopentylalcohol (critical temperature=276° C.; critical pressure=40 bar), diethylcarbinol (critical temperature=286° C.; critical pressure=39 bar), methylpropylcarbinol (critical temperature=287° C.; critical pressure=37 bar), methylisopropylcarbinol (critical temperature=283° C.; critical pressure=39 bar), dimethylethylcarbinol (critical temperature=271° C.; critical pressure=37 bar), 1-hexanol (critical temperature=337° C.; critical pressure=34 bar), 2-hexanol (critical temperature=310° C.; critical pressure=33 bar), 3-hexanol (critical temperature=309° C.; critical pressure=34 bar), 2-methyl-1-pentanol (critical temperature=331° C.; critical pressure=35 bar, 3-methyl-1-pentanol (critical temperature=387° C.; critical pressure=30 bar), 4-methyl-1-pentanol (critical temperature=330° C.; critical pressure=30 bar), 2-methyl-2-pentanol (critical temperature=286° C.; critical pressure=36 bar), 3-methyl-2-pentanol (critical temperature=333° C.; critical pressure=36 bar), 4-methyl-2-pentanol (critical temperature=301° C.; critical pressure=35 bar), 2-methyl-3-pentanol (critical temperature=303° C.; critical pressure=35 bar), 3-methyl-3-pentanol (critical temperature=302° C.; critical pressure=35 bar), 2,2-dimethyl-1-butanol (critical temperature=301° C.; critical pressure=35 bar), 2,3-dimethyl-1-butanol (critical temperature=331° C.; critical pressure=35 bar), 2,3-dimethyl-2-butanol (critical temperature=331° C.; critical pressure=35 bar), 3,3-dimethyl-1-butanol (critical temperature=331° C.; critical pressure=35 bar), 2-ethyl-1-butanol (critical temperature=307° C.; critical pressure=34 bar), 1-heptanol (critical temperature=360° C.; critical pressure=31 bar), 2-heptanol (critical temperature=335° C.; critical pressure=30 bar), 3-heptanol (critical temperature=332° C.; critical pressure=30 bar) and 4-heptanol (critical temperature=329° C.; critical pressure=30 bar); and more desirably may be methanol, propanol, or hexanol. When a solvent other than alcohol is used, a problem may occur where titanium nanoparticles which are primary particles are not formed, and where surfaces of the primary particles are covered with organic moieties, thereby failing to form a coating layer.

A concentration of the titanium dioxide precursor solution where the titanium dioxide precursor and the solvent are mixed may be 0.001 to 10 mol/L, and desirably 0.01 to 5 mol/L. When the concentration of the titanium dioxide precursor solution is less than 0.001 mol/L, only a small amount of titanium dioxide nanoparticles that are primary particles may be prepared during a given reaction time, thereby decreasing economic feasibility, whereas when the concentration of the titanium dioxide precursor solution exceeds 10 mol/L, the size of the primary particles will increase and degree of uniformity will decrease, thereby decreasing electrochemical performance.

The supercritical fluid conditions may be include a temperature of 200° C. or above, desirably 240° C. or above, and more desirably 240 to 600° C., and a pressure of 30 bar or above, desirably 40 to 600 bar, and more desirably 100 to 600 bar.

When the temperature and pressure for forming the supercritical fluid conditions are below the lower limit, an average diameter of titanium nanoparticles that are primary particles may exceed 100 nm, a crystallinity will be low, thereby decreasing the discharge capacity, and when the temperature and pressure for forming the supercritical fluid exceed the upper limit, the nanoparticles may agglomerate with one another under high temperature and high pressure conditions, thereby decreasing discharge capacity.

Furthermore, the agitating (S10) may be performed for 1 minute to 6 hours, desirably 15 minutes to 1 hour. When the agitating is performed for less than 1 minute, the degree of crystallinity of titanium dioxide nanoparticles that are primary particles will not increase but there may be a lot of impurities, and when the agitating is performed more than 6 hours, the nanoparticles will agglomerate with one another, thereby increasing the size of the particles and decreasing productivity.

The collecting (S20) is a step of collecting the anode active material after the reaction. It is a step of separating the micron-sized anode active material formed at the agitating (S10) including the titanium dioxide nanoparticles and the pores formed by the coupled nanoparticles from the solvent and nonreacted precursor material. The collecting (S20) may be, but without limitation, a centrifugation or filtering method.

The drying (S30) is a step of washing and then drying the anode active material to remove residual unreacted precursor or unreacted solvent remaining in the separated anode active material.

There is no limitation to the washing method as long as it may remove the remaining unreacted precursor or unreacted solvent, but desirably, water, methanol, ethanol, or tetrahydrafuran may be used.

Furthermore, there is no limitation to the drying method, but desirably, vacuum drying, oven drying, or freeze drying may be used.

A reaction temperature of the drying (S30) may be 30 to 100° C., and desirably 50 to 70° C. When the reaction temperature of the drying (S30) is less than 30° C., its drying time will increase, thereby decreasing economic feasibility, and when the reaction temperature of the drying (S30) exceeds 100° C., there occurs a problem that the material is calcined without being dried.

Furthermore, the drying (S30) may be performed for 5 to 50 hours, and desirably, for 12 to 36 hours. When the drying (S30) is performed for less than 5 hours, there may occur a problem of unreacted precursor or unreacted solvent remaining in the anode active material, and when the drying (S30) is performed for more than 50 hours, there may occur a problem of increase of manufacturing costs due to increased processing time.

The calcining (S40) is a step of calcining the anode active material precursor, that is, a step where surfaces of titanium nanoparticles that are primary particles are coated with titanium(III) ions (Ti³⁺) and carbon.

The calcining (S40) may be performed at 300 to 1000° C., and desirably at 600 to 800° C., for desirably 50 minutes to 10 hours. When the calcining is performed outside the aforementioned lower limits, the organic moieties present on the surface of the titanium dioxide nanoparticles will not transform to carbon, and titanium(IV) ions will not be reduced to titanium(III) ions, thereby reducing the degree of coating, and when the calcining is performed outside the aforementioned upper limits, it will cost a lot of money, thereby increasing the manufacturing costs.

Furthermore, the calcining (S40) may be performed under a condition where either of inert gas or inert gas containing Hz flows, and by using inert gas it is possible to inhibit unnecessary chemical changes thereby improving response stability, and by using Hz, it is possible to improve the efficiency of reduction from titanium(IV) ions (Ti^{4′}) to titanium(III) ions (Ti³⁺).

Furthermore, the gas may flow at a velocity of 50 to 200 ml/min, and desirably at a velocity of 75 to 150 ml/min. When the gas flows at a velocity below 50 ml/min, there may occur a problem that the manufacturing process time increases, and when the gas flows at a velocity above 200 ml/min, organic moieties present on the surface of the titanium dioxide nanoparticles may be washed off, thereby decreasing the degree of uniformity of the coating layer.

A micron-sized anode active material containing titanium dioxide nanoparticles prepared as aforementioned may be used as an electrode, and the electrode may further include an electroconductor, binder and electrolyte.

Furthermore, a micron-sized anode active material containing titanium dioxide nanoparticles prepared as aforementioned may be used as a secondary battery, and the secondary battery may further include an electrolyte and a separating film.

Hereinafter, desirable embodiments will be explained to help understanding of the present invention.

### Embodiment 1

Methanol is added into a container, and then titanium (IV) tetraisopropoxide is added therein such that its concentration is 1.0 mol/l. 4 ml of this solution is put into a high-temperature and high-pressure reactor having a volume of 10 ml. The reactor is placed into a salt-bath maintaining a temperature of 400° C., and the mixture solution is reacted by agitating for 15 minutes while maintaining the temperature of the reactor at 400° C. and pressure of 300 bar. When the reaction ends, the reacted solution is filtered, TiO₂ particles having a nano-to-micron hierarchical structure having mesopores are separated and collected, and the collected TiO₂ particles are washed with methanol and then dried in a vacuum oven of 60° C. and then dried for 24 hours. By calcining the dried TiO₂ particles for 2 hours at 600° C. under a condition where an argon mixture gas containing 5% of H₂ flows, a micron-sized anode active material containing TiO₂ nanoparticles are prepared where carbon and Ti³⁺ are double-coated on surfaces of the nanoparticles.

### Embodiment 2

Embodiment 2 is the same as embodiment 1, except that propanol is used as the solvent instead of methanol, to prepare a micron-sized anode active material containing TiO₂ nanoparticles double-coated with carbon and Ti³⁺ on the surfaces of the nanoparticles.

### Embodiment 3

Embodiment 3 is the same as embodiment 1, except that hexanol is used as the solvent instead of methanol, to prepare a micron-sized anode active material containing TiO₂ nanoparticles double-coated with carbon and Ti³⁺ on the surfaces of the nanoparticles.

### Embodiment 4

Embodiment 4 is the same as embodiment 1, except that the concentration of titanium(IV) tetraisoproproxide is 0.1 mol/l, to prepare a micron-sized anode active material containing TiO₂ nanoparticles double-coated with carbon and Ti³⁺ on the surfaces of the nanoparticles.

### COMPARATIVE EXAMPLE 1

Water is added to a container, and then titanium(IV) tetraisopropoxide is added therein such that its concentration is 1.0 mol/l. 4 ml of this solution is put into a high-temperature and high-pressure reactor having a volume of 10 ml. The reactor is placed into a salt-bath maintaining a temperature of 400° C., and the mixture solution is reacted by agitating for 15 minutes while maintaining the temperature of the reactor at 400° C. and pressure of 300 bar. When the reaction ends, the reacted solution is filtered, nano-sized TiO₂ particles are separated and collected, and the collected TiO₂ particles are washed with methanol and then dried in a vacuum oven of 60° C. and then dried for 24 hours. By calcining the dried TiO₂ particles for 2 hours at 600° C. under a condition where an argon mixture gas containing 5% of H₂ flows, an anode active material containing TiO₂ nanoparticles are prepared.

### COMPARATIVE EXAMPLE 2

Comparative example 2 is the same as comparative example 1, except that a micron-sized anode active material is prepared containing TiO₂ nanoparticles without going through the calcining.

### COMPARATIVE EXAMPLE 3

Comparative example 3 is the same as comparative example 1, except that air containing O₂ is used instead of using the argon mixture air containing 5% of H₂ in the calcining, to prepare a micron-sized anode active material containing TiO₂ nanoparticles.

### COMPARATIVE EXAMPLE 4

Comparative example 4 is the same as comparative example 1, except that the reactor is maintained at 100° C. and a pressure of 10 bar, to prepare a micron-sized anode active material containing TiO₂ nanoparticles double-coated with carbon and Ti³⁺ on the surfaces of the nanoparticles.

Hereinafter, [table 1] shows differences between the aforementioned embodiments and comparative examples.

TABLE 1

| | | Concen- | | | Reactor |
|---|---|---|---|---|---|
| | | tration | Calci- | Calcined | temperature/ |
| | Solvent | of precursor | nation | gas | pressure |
| Embodiment | Methanol | 1.0 mol/ [symbol] | ◯ | H₂ and Ar | 400° C./300 |
| 1 | | | | | bar |
| Embodiment | Propanol | 1.0 mol/ [symbol] | ◯ | H₂ and Ar | 400° C./300 |
| 2 | | | | | bar |
| Embodiment | Hexanol | 1.0 mol/ [symbol] | ◯ | H₂ and Ar | 400° C./300 |
| 3 | | | | | bar |
| Embodiment | Methanol | 0.1 mol/ [symbol] | ◯ | H₂ and Ar | 400° C./300 |
| 4 | | | | | bar |
| Comparative | Water | 1.0 mol/ [symbol] | ◯ | H₂ and Ar | 400° C./300 |
| example 1 | | | | | bar |
| Comparative | Methanol | 1.0 mol/ [symbol] | X | H₂ and Ar | 400° C./300 |
| example 2 | | | | | bar |
| Comparative | Methanol | 1.0 mol/ [symbol] | ◯ | O₂ and air | 400° C./300 |
| example 3 | | | | | bar |
| Comparative | Methanol | 1.0 mol/ [symbol] | ◯ | H₂ and Ar | 100° C./10 |
| example 4 | | | | | bar |

Hereinafter, characteristics of the anode active materials prepared according to embodiment 1 and comparative examples 1 to 3 are explained in detail with reference to the drawings attached.

Analysis on Characteristics of Anode Active Material Nanoparticles

[Measurements of Anode Active Material Nanoparticles by XRD]

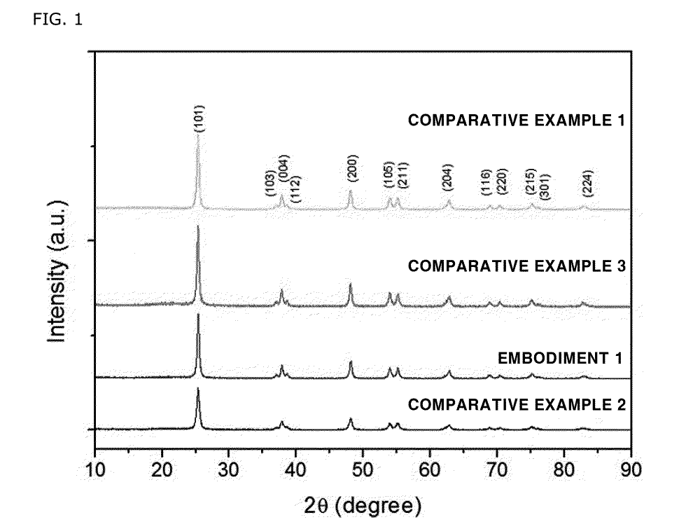

FIG. 1 is a graph of measurement by an X-ray diffractormeter (manufactured by Rigaku) to analyze components of anode active material nanoparticles.

Particles prepared according to embodiment 1, and comparative examples 1, 2, and 3 are used as measurement specimens.

As illustrated in FIG. 1, 20 values of the anode active material particles of embodiment 1 and comparative examples 1 to 3 show effective peaks of 25.3°, 37.8°, 48.0°, and 53.9°, and it can be seen that these effective peaks correspond to (101), (004), (220), and (105) of TiO₂ of anatase form (JCPDS No. 21-1270). Furthermore, in can be seen that the anode active material particles of embodiment 1, and comparative examples 1 to 3 do not contain impurities, and thus pure TiO₂ are formed.

[Measurements of Anode Active Material Nanoparticles by FT-IR]

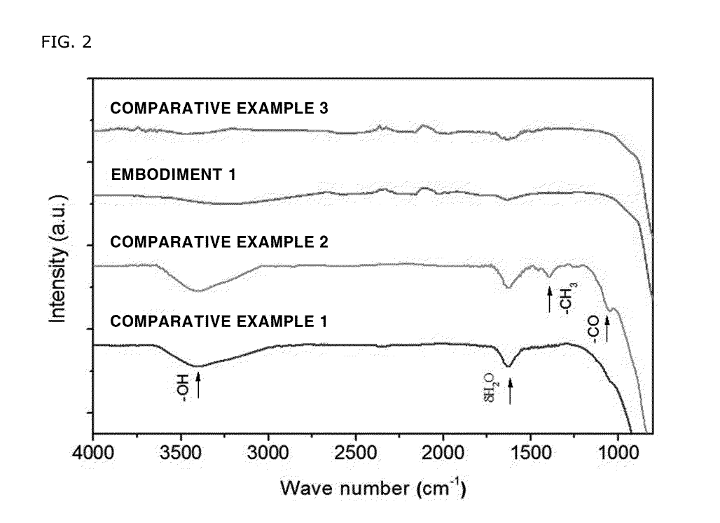

FIG. 2 is a graph of measurements by a Fourier Transform Infrared Spectroscopy (FT-IR, manufactured by Thermo Electron) conducted to identify whether or not surfaces of anode active material nanoparticles are modified with organic moieties.

Particles prepared according to embodiment 1, and comparative examples 2 and 3 were used as measurement specimens.

As illustrated in FIG. 2, in comparative example 2, —CH₃— group (1380 cm⁻¹), —C—O— group (1050 cm⁻¹) and —OH group (3000˜3750 cm⁻¹) are detected on the surfaces of TiO₂ particles prior to calcination, whereas in comparative example 1, only —OH group (3000-3750 cm⁻¹) are detected on the surfaces of TiO₂ particles prepared from water at its supercritical state, showing that surface modification is performed effectively when using supercritical methanol. Meanwhile, on the particle surfaces of calcined embodiment 1 and comparative example 3, peaks of —CH₂— group, and —CH₃ group and —OH group disappeared, which shows that when the particles are calcined at a high temperature, the organic moieties disappear from the surfaces of the nanoparticles.

[Measurements of Anode Active Material Nanoparticles by Raman Spectroscopy]

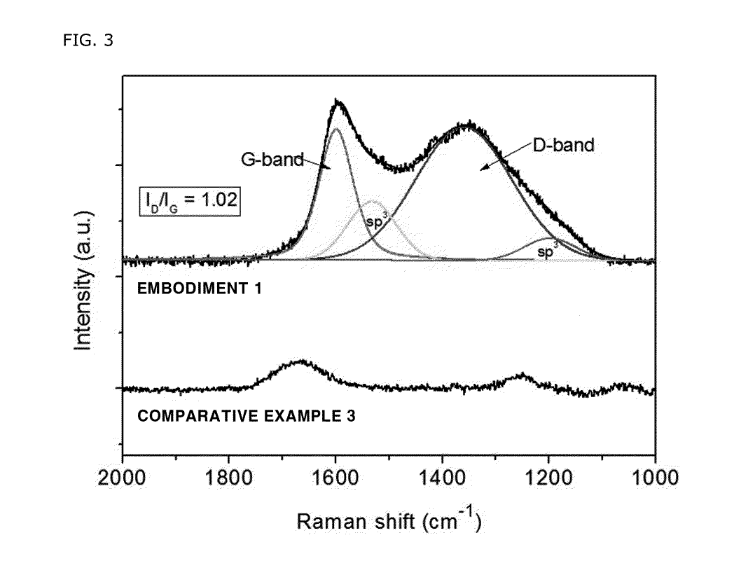

FIG. 3 is a graph of measurements by Raman spectroscopy (manufactured by Thermo Fisher Scientific) conducted to analyze carbon-coated anode active material nanoparticles.

Particles prepared according to embodiment 1 and comparative example 3 are used as measurement specimens.

As illustrated in FIG. 3, from the anode active material particles of embodiment 1, a G-band corresponding to a graphite carbon at about 1598 cm⁻¹ is detected, and a D-band corresponding to an amorphous carbon is detected at about 1355 cm⁻¹, which clearly demonstrated that carbon is formed on the surfaces of the anode active material particles. On the other hand, from the anode active materials of comparative example 3, the bands corresponding to carbon is not detected, which shows that carbon does not exist on the surfaces of the particles.

[Measurements of Anode Active Material Nanoparticles by STM, TEM, and HR-TEM]

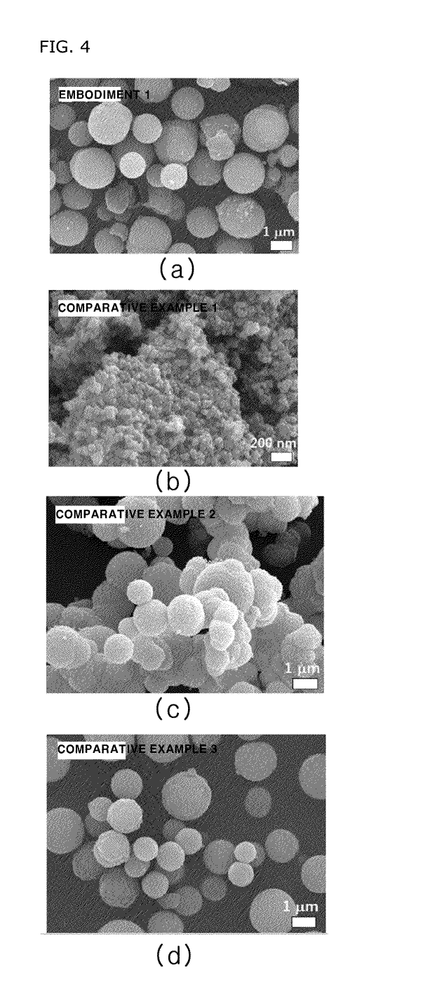

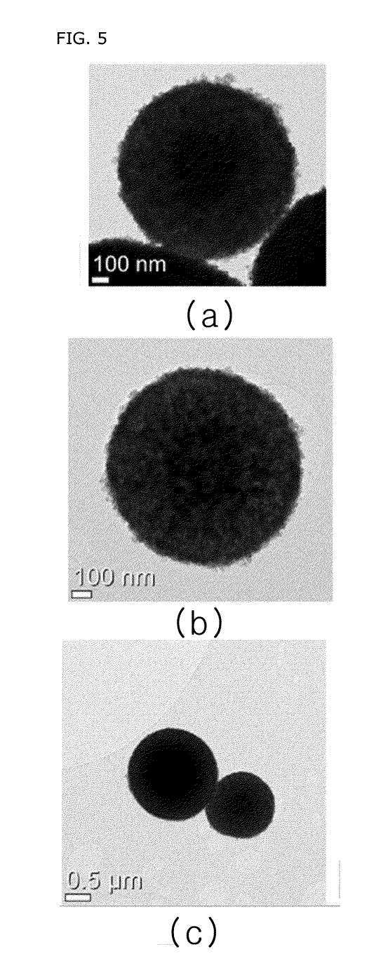

FIGS. 4 to 6 are photographs taken by an SEM (Scanning electron microscope, manufactured by Jeol), TEM (Transmission electron microscopy, manufactured by EFI), and HR-TEM (High-Resolution Transmission electron microscopy, manufactured by EFI), in order to analyze characteristics and forms of anode active material nanoparticles.

Particles prepared according to embodiment 1 and comparative examples 1 to 3 are used as measurement specimens.

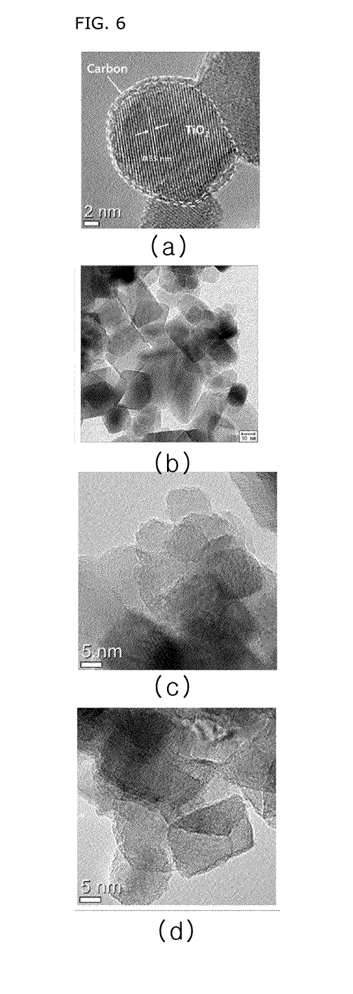

As illustrated in an HR-TEM image of FIG. 6, primary particles of the anode active material of embodiment 1 have an average diameter of about 20 to 50 nm, wherein carbon is uniformly coated on the surfaces of the primary nanoparticles by a thickness of 0.5 to 1.0 nm. Furthermore, mesopores of about 10 nm are formed between the primary nanoparticles coated with carbon. Meanwhile, as can be seen from the TEM and SEM images, the primary nanoparticles have agglomerated with one another, forming micron globular secondary particles having a diameter of about 1.0 to 2.5 mm.

The anode active material nanoparticles prepared using a supercritical water of comparative example 1 have a diameter of 25 to 75 nm which is greater than the diameter of primary particles of the anode active material prepared according to embodiment 1. Thus, it can be seen that in the case of TiO₂ prepared using a supercritical methanol, the surfaces of TiO₂ particles are coated with organic moieties, and thus particle growth is restricted. Meanwhile, in the case of the anode active particles of comparative example 2 before calcinations and the anode active material particles of comparative example 3 calcined in an air atmosphere, nano-to-micron hierarchical structure TiO₂ anode active material particles having mesopores are formed, but carbon is not coated on the surface of the primary particles.

[Measurements of Anode Active Material Nanoparticles by XPS]

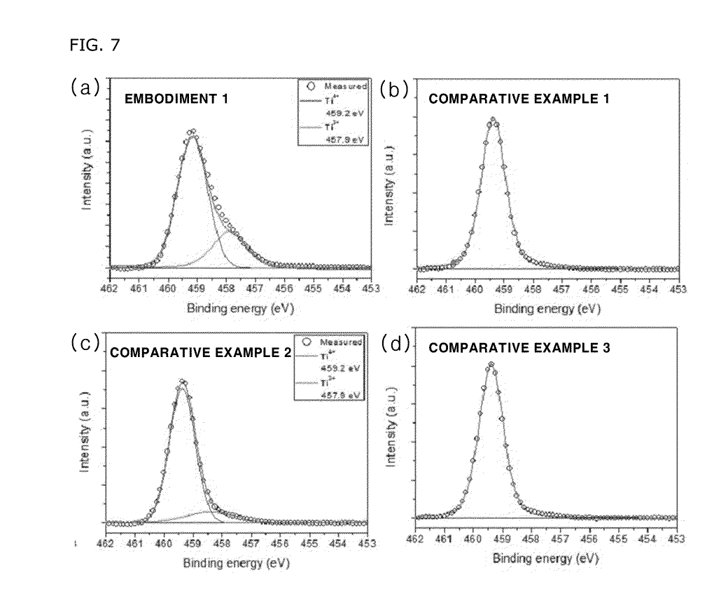

FIG. 7 is a graph of measurements by an XPS (X-ray photoelectron spectroscopy, manufactured by ULVAC-PHI) performed to analyze surfaces of anode active material particles.

Particles prepared by embodiment 1 and comparative examples 1 to 3 are used as measurement specimens.

As illustrated in FIG. 7, from Ti P_{3/2} graph of anode active material particles of embodiment 1, a peak corresponding to Ti⁴⁺ at 459.2 eV and a peak corresponding to Ti³⁺ at 457.9 eV are detected, wherein the area of Ti³⁺ peak is about 24% of the total Ti, showing that a significant amount of surfaces of the anode active material particles are coated with Ti³⁺. Meanwhile, in comparative example 1 and comparative example 3, peaks of Ti³⁺ are not detected, showing that in the case of the surfaces of anode active material particles prepared using a supercritical water and particles of anode active material particles of comparative example 3 prepared using the supercritical methanol and then calcined under an air atmosphere, Ti³⁺ does not exist. Meanwhile, in the case of the anode active material prepared from a supercritical methanol before calcinations as in comparative example 2, Ti³⁺ is detected, but the amount is about 14% which is smaller than the anode active material prepared after calcinations under an Ar/H₂ atmosphere.

[Measurements of Anode Active Material Nanoparticles by Nitrogen Adsorption]

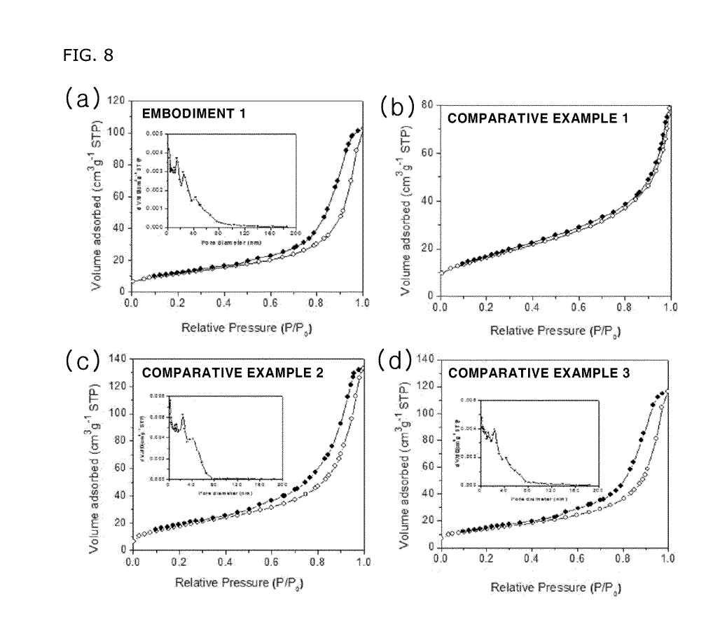

FIG. 8 is graph of measurements performed using a nitrogen adsorption and desorption method (of Belsorp-mini II apparatus, manufactured by BEL) in order to analyze specific surface areas and pores of anode active material particles.

Particles prepared according to embodiment 1 and comparative examples 1 to 3 are used as measurement specimens.

As illustrated in FIG. 8, in the case of the anode active material of embodiment 1, the N₂ adsorption-desorption isotherm curve shows hysteresis, which means that mesopores are formed. As a result of analyzing the pores by the Barrett-Joyner-Halenda (BJH) method, it can be seen that a size of the pore is 5 to 80 nm. Meanwhile, in the case of the anode active material of comparative examples 2 and 3, the N₂ adsorption-desorption isotherm curve of type IV shows a hysteresis, which means that mesopores are formed. However, in the case of the anode active material prepared using the supercritical water of comparative example 1, the N₂ adsorption-desorption isotherm curve of type II does not show a hysteresis, which means that mesopores are not formed.

It can be seen that in the case of embodiment 1, particles are calcinations under an Ar/H₂ atmosphere using the supercritical methanol and nano-to-micron hierarchical structure TiO₂ anode active material particles having mesopores and double-coated with carbon and Ti³⁺ are formed, but in the case of using a supercritical water according to comparative example 1, nanoparticles that are not coated with carbon and Ti³⁺ and do not have mesopores, and in the case of comparative example 2, nano-to-micron hierarchical structure TiO₂ anode active material particles prepared using the supercritical alcohol prior to calcinations have mesopores where Ti³⁺ is coated but carbon is not coated, and in the case of comparative example 3, nano-to-micron hierarchical structure TiO₂ anode active material particles are formed using the supercritical methanol and the particles calcined at an air atmosphere are not coated with carbon and Ti³⁺.

Measurement of Discharge Capacity of a Battery Containing Anode Active Material Nanoparticles

An anode is prepared using acetylene black as a conductive agent and PVDF (polyvinylidene fluoride) as a binder in order to analyze electrochemical characteristics of TiO₂ anode active material particles prepared according to the embodiments and comparative examples. Herein, a slurry is prepared by mixing the anode active material, conductive agent, and binder in a weight ratio of 87:10:3, NMP (having n-methyl pyrrolidone) as a solvent. The prepared slurry is deposited on a copper foil, and then dried in an oven at 80° C. for 6 hours or more. As an electrolyte solution, LiPF₆ (hexafluorides lithium phosphate) is dissolved in EC (ethylene carbonate)/EMC (ethyl methyl carbonate)/DEC (Diethyl carbonate) mixed solvent (volume ratio of EC:DMC:EMC=1:1:1). Half cells were fabricated with the lithium metal as a counter electrode.

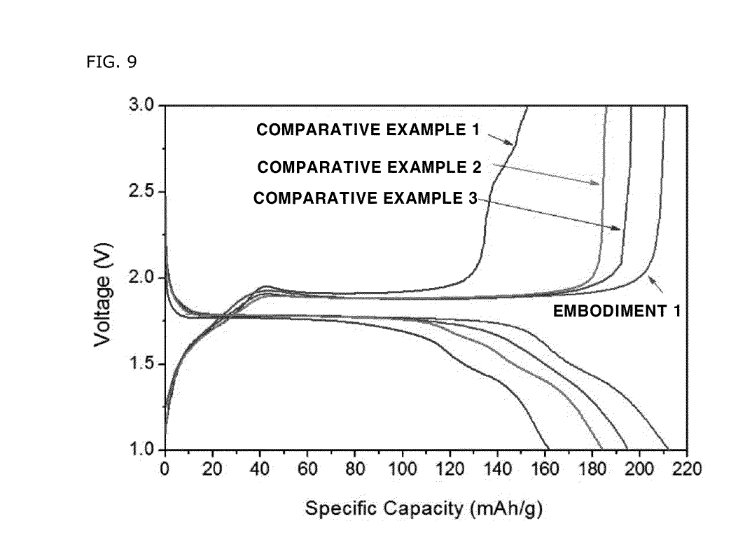

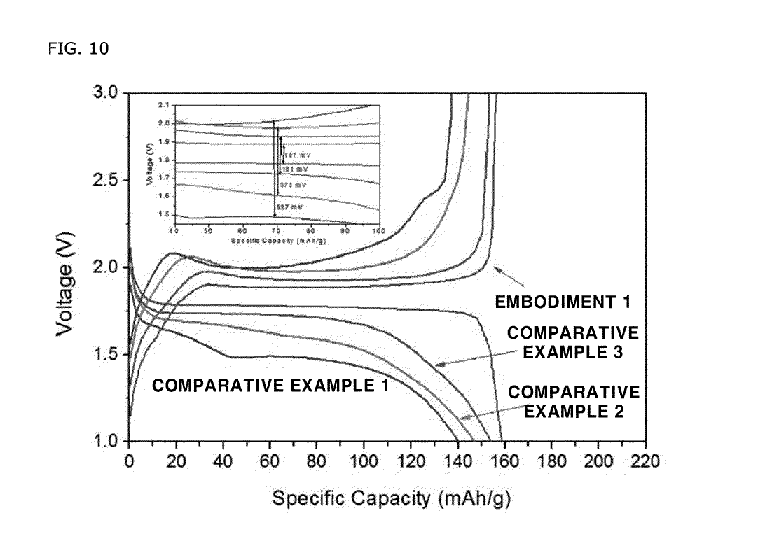

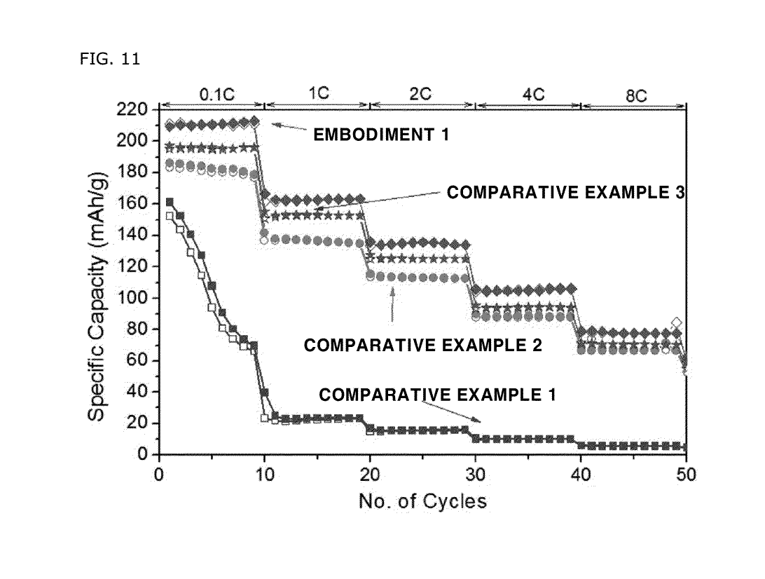

FIG. 9 illustrates initial charge/discharge cycles of the prepared battery at 0.1 C and 1.0˜2.5V, and FIG. 10 illustrates initial charge/discharge cycles at 1.0 C, and FIG. 11 illustrates charge/discharge properties of the battery while changing the charge/discharge rates of 0.1 C to 8 C.

As illustrated in FIG. 9, it can be seen that a battery that uses the anode active material particles prepared according to embodiment 1 has an initial discharge capacity of 212 mAh/g at 0.1 C that is significantly higher than an initial discharge capacity of comparative example 1 that is 162 mAh/g, an initial discharge capacity of comparative example 2 that is 184 mAh/g, and an initial discharge capacity of comparative example 3 that is 195 mAh/g.

As illustrated in FIG. 10, it can be seen that a battery that uses the anode active material particles prepared according to embodiment 1 of the present invention has an initial discharge capacity of 159 mAh/g under 1.0 C that is higher than an initial discharge capacity of 154 mAh/g of comparative example 1 and higher than an initial discharge capacity of 147 mAh/g of comparative example 2 and also higher than an initial discharge capacity of 140 mAh/g. Furthermore, a battery that uses the anode active material particles prepared according to embodiment 1 has a difference of a charge plateau potential and discharge plateau potential of about 107 mV that is significantly smaller than comparative example 2 (373 mV) and comparative example 3 (191 mV).

As illustrated in FIG. 11, the battery that uses the anode active material particles prepared according to embodiment 1 of the present invention have larger capacities that the batteries that uses the anode active material particles prepared according to comparative examples 1, 2, and 3, based on measurements of charge/discharge capacities conducted while changing charge/discharge rates from 0.1 C to 8 C. Accordingly, it can be seen that the surfaces of the anode active material particles prepared according to embodiment 1 are double-coated with carbon and Ti³⁺ and forms a nano-to-micron hierarchical structure having mesopores, thereby exhibiting high initial charge/discharge capacities, high rate capabilities, and low polarization.

Furthermore, [Table 2] below compares initial discharge capacities at a rate of 0.1 C and discharge capacities at a rate of 8 C of the batteries that uses the anode active material nanoparticles prepared according to embodiments 1 to 4, and comparative example 1 of the present invention.

TABLE 2

| | Initial discharge | Discharge |
|---|---|---|
| | capacity | capacity under |
| | under 0.1C condition | 8C condition |
| Embodiment 1 | 212 (mAh/g) | 78 (mAh/g) |
| Embodiment 2 | 210 (mAh/g) | 80 (mAh/g) |
| Embodiment 3 | 205 (mAh/g) | 75 (mAh/g) |
| Embodiment 4 | 215 (mAh/g) | 80 (mAh/g) |
| Comparative example 1 | 162 (mAh/g) | 5 (mAh/g) |

As illustrated in table 2 above, it can be seen that the batteries using the anode active material nanoparticles prepared according to embodiments 1 to 3 and 4 of the present invention have initial discharge capacities that are significantly higher than comparative example 1 under a condition of 0.1 C and under a condition of 8 C. It seems because the size of a nanoparticle of comparative example 1 is greater than the size of a nanoparticle of embodiment 1, the insertion/deinserion kinetics of lithium ions during charging/discharge is slow and electroconductive material does not exist on the surfaces of the nanoparticles, thereby decreasing the electroconductivity.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. A micron sized anode active material comprising titanium dioxide nanoparticles double-coated with titanium(III) ions (Ti³⁺) and carbon,
wherein the titanium dioxide nanoparticles are coupled to one another to form the micron sized structure, thereby forming pores.

2. The material according to claim 1,
wherein a thickness of the double-coating is 0.3 nm to 1.5 nm.

3. The material according to claim 1,
wherein a diameter of the titanium dioxide nanoparticle is 20 nm to 50 nm.

4. The material according to claim 1,
wherein an average diameter of the pore is 5 nm to 20 nm.

5. The material according to claim 1,
wherein a diameter of the anode active material is 1.0 μm to 3.0 μm.

6. A method for preparing a micron sized anode active material containing titanium dioxide nanoparticles, the method comprising:
agitating a titanium precursor solution containing titanium oxide precursor and a solvent under a supercritical fluid condition to prepare an anode active material precursor;
collecting the anode active material precursor;
washing and drying the anode active material precursor; and
calcining the anode active material precursor.

7. The method according to claim 6,
wherein the supercritical fluid condition is a temperature of 200° C. to 600° C. and a pressure of 30 bar to 600 bar.

8. The method according to claim 6,
wherein a concentration of the titanium precursor solution is 0.001 mol/L to 10 mol/L.

9. The method according to claim 6,
wherein the agitating is performed for 1 minute to 6 hours.

10. The method according to claim 6,
wherein the collecting is performed by a centrifugation or filtering method.

11. The method according to claim 6,
wherein the drying is performed for 5 to 50 hours at a temperature of 30° C. to 100° C.

12. The method according to claim 6,
wherein the calcining is performed for 10 minutes to 24 hours at a temperature of 300° C. to 1000° C.

13. The method according to claim 6,
wherein the calcining is performed under a condition where an inert gas or an inert gas comprising H₂ flows.

14. The method according to claim 13,
wherein the gas flows at a velocity of 50 ml/min to 200 ml/min.

15. The method according to claim 6,
wherein the solvent is alcohol.

16. The method according to claim 15,
wherein the alcohol is selected from a group consisting of methanol, ethanol, propanol, isopropylalcohol, butanol, isobutanol, 2-butanol, tert-butanol, n-pentanol, isopentyl alcohol, 2-methyl-1-butanol, neopentyl alcohol, diethyl methanol, methyl propyl methanol, methyl isopropyl methanol, dimethyl ethyl methanol, 1-hexanol, 2-hexanol, 3-hexanol, 2-methyl-1-pentanol, 3-methyl-1-pentanol, 4-methyl-1-pentanol, 2-methyl-2-pentanol, 3-methyl-2-pentanol, 4-methyl-2-pentanol, 2-methyl-3-pentanol, 3-methyl-3-pentanol, 2,2-dimethyl-1-butanol, 2,3-dimethyl-1-butanol, 2,3-dimethyl-2-butanol, 3,3-dimethyl-1-butanol, 2-ethyl-1-butanol, 1-hptanol, 2-heptanol, 3-heptanol, and 4-heptanol.

17. The method according to claim 6,
wherein the titanium precursor is selected from a group consisting of titanium(IV) tetramethoxide, titanium(IV) tetraethoxide, titanium(IV) tetrapropoxide, titanium(IV) tetraisopropoxide, titanium(IV) tetrabutoxide, titanium(IV) tetraisobutoxide, titanium(IV) tetrapentoxide, titanium(IV) tetraisopentoxide, and a salt thereof.
